(19) United States
(12) Patent Application Publication
(10) Pub. No.: US 2026/0054550 A1
(43) Pub. Date: Feb. 26, 2026

(54) WINDOW UNIT, VEHICLE WINDOW UNIT, MOLD AND ASSOCIATED METHODS AND USE

(71) Applicant: AGC GLASS EUROPE, Louvain-la-Neuve (BE)

(72) Inventors: Godelieve VERBOVEN, Gosselies (BE); Michael REHMANN, Gosselies (BE); Frank BEKAERT, Gosselies (BE)

(73) Assignee: AGC GLASS EUROPE, Louvain-la-Neuve (BE)

(21) Appl. No.: 19/104,785

(22) PCT Filed: Sep. 21, 2023
(86) PCT No.: PCT/EP2023/076158

§ 371 Date: Feb. 19, 2025

(30) Foreign Application Priority Data
Sep. 30, 2022 (EP) 22199299.3

(51) Int. Cl. B60J 1/00; B60J 10/16; B60R 13/04

(52) U.S. Cl. CPC B60J 1/006; B60J 1/007; B60J 10/16; B60R 13/04

(57) ABSTRACT

A window unit with a glazing panel, a frame with a profile that encompasses the glazing panel's edge, and grips the glazing panel on at least two peripheral sides as a ring; the frame has a primary part in the form of a hard component. The frame's primary part has at least one clip-like assembly that has top and bottom elements; the clip-like assembly clips and maintains the trim element's lug between the top and bottom elements. The top element is shifted from the bottom element along the edge. The clip-like assembly and the primary part are a single component. The top and bottom elements are flexible in a perpendicular direction to the axis of penetration of a trim element plugged into the clip-like assembly.

### TECHNICAL FIELD

The present invention relates to a window unit comprising a glazing panel, a frame which has a frame profile and encompasses the edge of the glazing panel on at least two peripheral sides, and grips the glazing panel or encompasses the glazing panel on at least two peripheral sides in the form of a ring; the frame comprising a primary part which is in the form of a hard component, in general and, more specifically, to an enhanced window unit comprising a at least one clip-like assembly to clip and to maintain a trim element along a part of an edge.

Thus, the invention concerns multiple domains where a window unit comprising a at least one clip-like assembly to clip and to maintain a trim element along a part of an edge. Said window unit is designed to be mounted on a structure. The structure can be a fixed object such as a building or a bodywork of a mobile object such as a motor vehicle, a car, a bus, a truck, a train, a boat, or alike. Such window unit can be used outdoor as well as indoor.

### BACKGROUND ART

Constructors often mask these unattractive seals behind metallic trim elements or trim elements made from synthetic material coated with a metallic film. These trim elements have to be fastened sufficiently robustly such that there is no risk of their detaching accidentally. It must also be possible for them to be detached, for example at the time of work or during replacement of the trim in the event of a defect in the latter, thereby not requiring replacement of the full window/paint provided on the vehicle.

Various methods have been proposed for fastening these trim elements, these methods often involving a link between the seal and the trim. Usually, these fastenings are achieved by means of clip-type means so that installation is simple and quick. In these assembling operations, the trim, which essentially comprises a metallic profile, is fastened to a component incorporated into the seal itself. The positioning of the various elements often requires one or more operations that can be effected only manually, which is unsatisfactory from the economic standpoint. With a view to simplifying these operations, solutions have recourse to fastening methods comprising the clipping of the profile constituting the trim to a corresponding element integrated in the peripheral seal when the latter is formed on the window. In particular, Belgian patent application BE 2013/0441 has proposed a trim fastening comprising two distinct elements, the first element being a base molded directly with the seal and the second comprising clips designed to receive the lug of the trim. The second element, meanwhile, is assembled on the base by engagement of the two elements one relative to the other in a movement that opposes the separation of the two elements. This solution offers the advantage of it being possible to replace the second element if it is defective.

However, this solution leads to the formation of shrinkage cavities in the region of the seal when the fastening element is positioned.

To reduce this shrinkage cavities, the European patent application EP3461668 discloses a clip inserted on the glazing unit. This solution requires the assembly of parts (primary part, clips, . . . ) that are manufactured separately. This solution also requires a lot of handling to manufacture the glazing, while making the assembly with the trim element more complex.

### SUMMARY OF INVENTION

Thus, to solve these problems, the present invention proposes an enhanced window unit.

The present invention relates, in a first aspect, to a window unit comprising a glazing panel and a frame which has a frame profile and encompasses the edge of the glazing panel on at least two peripheral sides, and grips the glazing panel or encompasses the glazing panel on at least two peripheral sides in the form of a ring. The frame comprises a primary part which is in the form of a hard component.

The solution as defined in the first aspect of the present invention is based on that the primary part of the frame comprises at least one clip-like assembly, the clip-like assembly comprises a top element, a bottom element; the at least one clip-like assembly being designed to clip and maintain a lug of a trim element between the top element and the bottom element.

The solution as defined in the first aspect of the present invention is also based on that the top element is shifted from the bottom element along the edge to stabilize a clipping with a lug of a trim element.

The solution as defined in the first aspect of the present invention is also based on that the at least one clip-like assembly and the primary part are formed as a single component to at least reduce the handling.

The solution as defined in the first aspect of the present invention is also based on that the top element and the bottom element are designed to be flexible in a direction substantially perpendicular to the axis of penetration of a trim element to be plugged into the at least one clip-like assembly to be able to insert and plug a lug of a trim element.

Thus, the invention can also solve the need to easily plug, maintain a trim element along a window unit while having the possibility to change this trim element with an easy handling.

The invention permits to obtain a robust and dimensionally stable window unit.

The present invention relates, in a second aspect, to a vehicle window unit comprising a window unit according to the first aspect of the present invention. The vehicle window unit also comprises a trim element comprising a lug designed to be clipped and maintained in a clip-like assembly.

The solution as defined in the second aspect of the present invention is based on that the lug is inserted into the at least one clip-like assembly, between the top element and the bottom element.

The present invention relates, in a third aspect, to a method to produce a window unit according to the first aspect of the invention, wherein the method comprises a step of injecting the primary part and the at least one clip-like assembly in a single step onto the glazing panel.

The present invention relates, in a fourth aspect, to a method to assemble a vehicle glazing unit according to the second aspect of the invention, wherein the method comprises following steps:
Step A. Providing a glazing unit according to the first aspect of the invention;
Step B. Providing a trim element comprising a lug designed to be clipped and maintained in a clip-like assembly;
Step C. Assembling the trim element by clipping the lug between the top element and the bottom element of the at least one clip-like element.

The present invention relates, in a fifth aspect, to a mold to produce a window unit according to claims 1 to 8, the mold being designed to receive at least a part of the glazing unit on which the primary part will be inserted, characterized in that the mold comprises a cavity to create by injection the primary part and the at least one clip-like assembly.

The present invention relates, in a sixth aspect, to an use to clip a trim element with an at least one clip-like assembly comprised in a primary part of a frame which has a frame profile and encompasses the edge of a glazing panel on at least two peripheral sides, and grips the glazing panel or encompasses the glazing panel on at least two peripheral sides in the form of a ring; the frame comprising a primary part (4) which is in the form of a hard component the clip-like assembly comprises a top element (51), a bottom element (52); the at least one clip-like assembly being designed to clip and maintain a lug of the trim element between the top element and the bottom element, the top element being shifted from the bottom element along the edge, the at least one clip-like assembly and the primary part being formed as a single component and the top element and the bottom element being designed to be flexible in a direction substantially perpendicular to the axis of penetration of a trim element to be plugged into the clip-like assembly.

It is noted that the invention relates to all possible combinations of features recited in the claims or in the described embodiments.

The following description relates to automotive but it's understood that the invention may be applicable to others fields like transportation applications in general or building applications or alike.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale.

The drawings do not restrict the invention in any way. More advantages will be explained with examples.

FIG. 1 is a schematic 3D view of a window unit according to the first aspect of the invention.

FIG. 2 is a schematic 3D view of a vehicle window unit according to the second aspect of the invention.

FIG. 3 is a schematic 3D view of a clip-like assembly.

FIG. 4 is a schematic 2D view of a clip-like assembly.

FIG. 5 is a schematic sectional view of a clip-like assembly of FIG. 5 along plane AA′.

FIG. 6 is a schematic sectional view of a clip-like assembly of FIG. 5 along plane BB′.

FIG. 7 is a schematic sectional view of a clip-like assembly of FIG. 5 along plane CC′.

FIG. 8 is a schematic view of a method according to the fourth aspect of the present invention.

### DETAILED DESCRIPTION

In this document to a specific embodiment and include various changes, equivalents, and/or replacements of a corresponding embodiment. The same reference numbers are used throughout the drawings to refer to the same or like parts. Other variations can be envisaged within the scope of the claims.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated. herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

It is an object of the present invention to alleviate the above described problems.

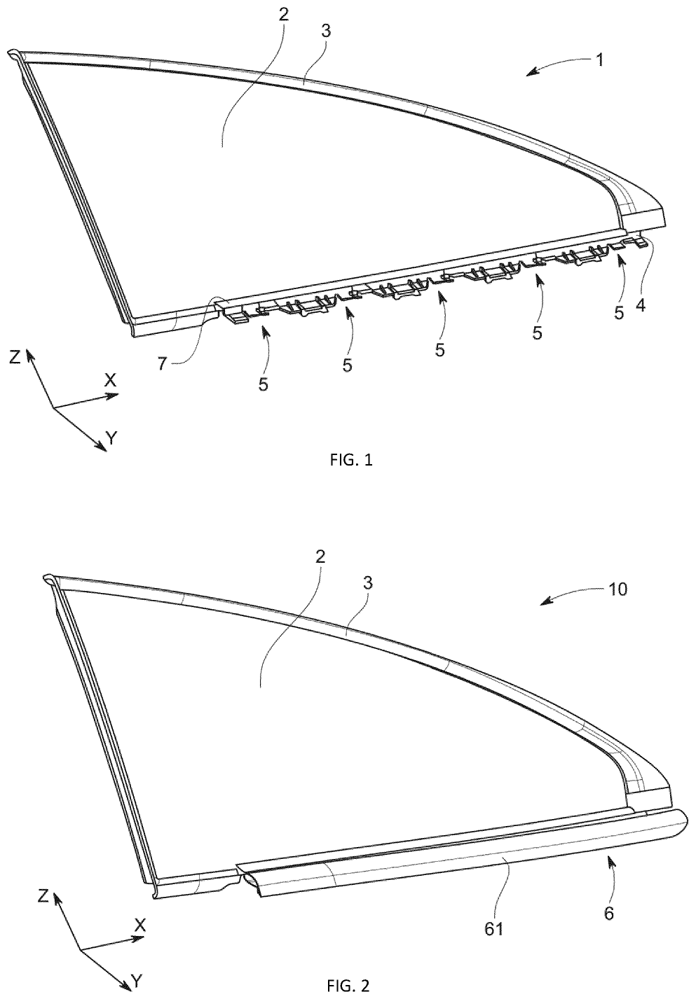

According to a first aspect of the invention, as illustrated in FIG. 1, the invention relates to a window unit 1 comprising a glazing panel 2 and a frame 3.

### <Glazing Panel>

In one embodiment, the glazing panel can comprises at least one glass sheet.

In another embodiment, due to reduction of induced deformations on the glazing panel, the glazing panel can comprise a laminated glass panel. The laminated glass panel comprises glass sheets maintained by one or more interlayers positioned between glass sheets. The interlayers employed are typically polyvinyl butyral (PVB) or ethylene-vinyl acetate (EVA) for which the stiffness can be tuned. These interlayers keep the glass sheets bonded together even when broken in such a way that they prevent the glass from breaking up into large sharp pieces.

The material of the glass sheet can independently be, for example, soda-lime silica glass, borosilicate glass, aluminosilicate glass or other materials such as thermoplastic polymers or polycarbonates which are especially known for automotive applications. References to glass throughout this application should not be regarded as limiting.

The glass sheet can independently be a clear glass or a coloured glass, tinted with a specific composition of the glass or by applying a decorative coating, paint or a plastic layer for example. The glass sheet can have any shape to fit to the opening such as a rectangular shape, in a plan view by using a known cutting method. As a method of cutting the glass sheet, for example, a method in which laser light is irradiated on the surface of the multi-glazed window to cut the glass sheet, or a method in which a cutter wheel is mechanically cutting can be used.

The glass sheet can independently be manufactured by a known manufacturing method such as a float method, a fusion method, a redraw method, a press molding method, or a pulling method. As a manufacturing method of the glass sheet, from the viewpoint of productivity and cost, it is preferable to use the float method.

In the case of a laminated glass panel, it could be advantageous to have varying thicknesses of glass sheets to reduce weight and noise. Due to of induced deformations on the glazing panel, thin glass sheets with a thickness less than 1 mm can be used without be bent or deformed. Thus, such thin glass sheet can keep the desired design.

The shape of the window unit in a plan view (in the X-Z plane) is usually a triangle, especially for a window unit used as a quarterlight window unit. Depending of the application, the shape is not limited to a triangle and may be a rectangle, a trapeze, a circular-shape, a hex or the like.

The glazing panel can be a flat or curved panel to fit with the design of the car. The glazing panel can be processed, ie annealed, tempered, . . . to respect with the specifications of security and anti-thief requirements. A heatable system, for example a coating or a network of wires, can be applied on the glazing panel to add a defrosting and/or a demisting function for example.

### <Frame>

According to the invention, the frame 3, which has a frame profile and encompasses the edge of the glazing panel on at least two peripheral sides, and grips the glazing panel or encompasses the glazing panel on at least two peripheral sides in the form of a ring, comprises a primary part 4 which is in the form of a hard component. It is understood that a hard component is a component dimensionally stable with a young modulus higher than 1000 MPa, preferably the hard component is a component dimensionally stable with a young modulus higher than 1500 MPa.

### <Primary Part>

In a preferred embodiment, the hard component is a polypropylene based material. Other hard materials, with a young modulus higher than 1000 MPa, as polyamide, specific styrenic, ABS, specific PVC and others can be also used.

In some preferred embodiments, the hard component can be reinforced with fillers (glass fibres, glass beads, calcium carbonate, talc, silica, wollastonite, clay, calcium sulphate fibres, mica), i.e. a polypropylene reinforced with 30% of glass fibers (PP 30GF) having a young modulus higher than 1500 MPa, about 1680 MPa.

In one embodiment of the invention, the primary part is in direct contact with the glazing panel meaning that the primary part is injected onto the glazing panel directly without any other material between the primary part and the surface of the glazing panel. The glazing panel can have locally a bonding agent or primer material to ensure tightness and/or to promote the encapsulation of the primary part onto the glazing panel.

The primary part can be overmolded on the glazing panel. To facilitate the process, the primary part is preferably injected into a mold to be encapsulated on the glazing panel.

The primary part can have a specific shape to fulfil with the requirement of the desired application. In some embodiments, the primary part can have extensions 41 to ensure the mechanical strength of the window unit.

### <Secondary Part>

In one embodiment of the invention, the frame can comprise a secondary part 7 which is in the form of soft component, placed at least partially over the primary part. The secondary part allows to thigh the window unit on the structure where it is fixed. Such structure can be a car body, a building, . . . .

The secondary part can be injected in a step, done after the step of injecting the primary part, over at least partially the primary part. Preferably, the secondary part is a single part. In some embodiments, the secondary part can be locally in contact with the glazing panel to ensure the aesthetic and the tightness of the window unit.

In another embodiment, at least a portion of the secondary part is in contact with the glazing panel and preferably at least in contact with the glazing panel at the level of the at least one constraints releasing mean.

The soft component has a natural chemical cohesive bonding with the hard component.

The soft component has a young modulus lower than 1000 MPa. The soft material, which has a young modulus lower than 1000 MPa can be made of thermoplastic elastomer based material. Styrenic based and vulcanized thermoplastics elastomer are generally used. The soft component is in another embodiment a soft polyvinyl chloride.

The soft component is used to give the final surface aspect of the frame and also to fit the window unit to the car body. Effectively, the softness of the material allow interferences between the carbody and the window unit by the use of soft lips. Soft component is sometimes also used to insure a sealing function between the carbody and the encapsulated window unit.

In a preferred embodiment, the soft component is a thermoplastic elastomer (TPE) based material.

According to one embodiment of the present invention, the frame profile encompassing the edge of the glazing panel on at least one peripheral side and is made of soft component which has a natural chemical cohesive bonding with the hard material. Thus, a good adhesion between the frame profile and the primary part may be obtained without using a primer between the two parts.

FIG. 2 illustrates a vehicle window unit 10 to be mounted on a bodywork of a vehicle such as a car. The vehicle window unit 10 comprises a window unit comprising a glazing panel 2 and a frame 3.

### <Trim Element>

The vehicle window also comprises a trim element 6.

In this representation, the trim element 6 has an exterior surface 65 designed to mask a part of the primary part 4, and a part of the secondary part if exists.

The trim element is generally an elongated element, substantially parallel to the edge of the glazing unit with a well finished exterior surface 65.

The trim element can be flat or curved. The trim element can have any shape in order to mask the part of the window unit that should not be visible once mounted on a structure.

The trim element can be made of plastic-based material or a metal such as aluminium.

The trim element can have a coating, a film, or alike on the external surface for aesthetic reasons such as matching with the colour of the structure or giving a specific finish aspect.

As illustrated in FIG. 6 to FIG. 8, on the internal face 66 that is turned toward the seal, the trim element comprises a lug 61. The trim element can comprises extensions 62, 63 that permits to well positioned the trim element between the bodywork and the window unit and/or permits to reinforced the trim element.

According to the invention, the lug can have any shape that able to be clipped and maintained in the clip-like assembly.

Coming back to FIG. 2, the lug 61 is inserted (not shown) into the at least one clip-like assembly to be clipped and maintained on the window unit.

The lug can be a punctual or elongated lug, extending along the length of the trim element meaning in the X-axis in such representations, depending of the desired application.

### <Clip-Like Assembly>

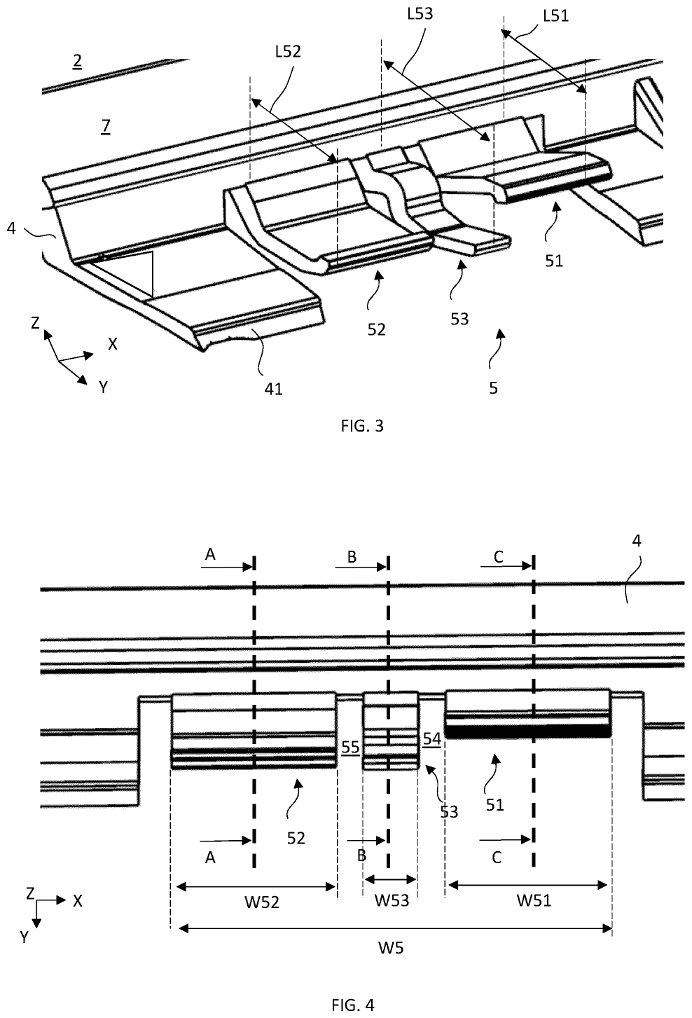

As illustrated in FIG. 3 and FIG. 4, the primary part 4 of the frame 3 comprises at least one clip-like assembly 5.

According to the invention, the at least one clip-like assembly 5 and the primary part 4 are formed as a single component. That means that the at least one clip-like assembly 5 and the primary part 4 are produced with the same material and during a single step.

The clip-like assembly comprises a top element 51, a bottom element 52. The at least one clip-like assembly is designed to clip and maintain a lug of a trim element between the top element and the bottom element.

Usually, a clip is composed of a top element and a bottom element positioned one above the other, in the Z-axis, to plug between these two elements a trim element.

According to the invention, to reduce the shrinkage cavities, the top element 51 is shifted from the bottom element along the edge, meaning that the top element 51 is moved from the bottom element 52 substantially along the X-axis in these figures. It is understood that the clipping or the plugging of a trim element is performed by the top element and the bottom element, there is no need for another element, designed to clip to plug and to maintain a trim element into the clip-like element, of the clip-like element.

It is understood that the top element and the bottom element are designed to be flexible in a direction substantially perpendicular to the axis of penetration of a trim element to be plugged into the clip-like assembly 5. In this representation, the axis of penetration is substantially along the Y-axis and thus perpendicular to locally the edge of the window unit, the X-axis in such representations.

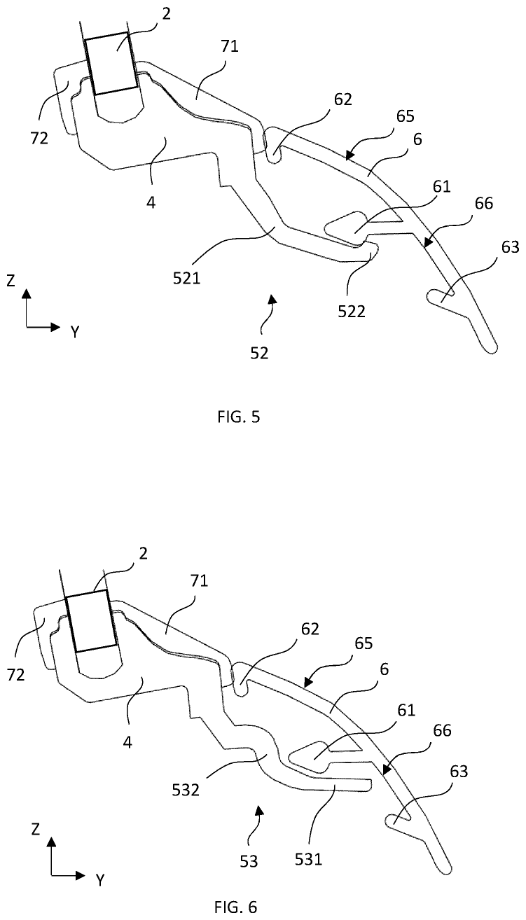

FIG. 5 illustrates a bottom element according to the invention. In some embodiments, the bottom element 52 can have an arm 521 designed to be flexible in a direction substantially perpendicular to the axis of penetration of a trim element to be plugged into the clip-like assembly even if the bottom element is made of a rigid material such as Polypropylene, meaning that the shape, the length, the thickness and/or the width can vary depending on the application and on the trim element to plug. The bottom element can also comprises an end part 522. The end part can comprises a hook-like element to maintain a trim element once the trim element is plugged into the clip-like assembly.

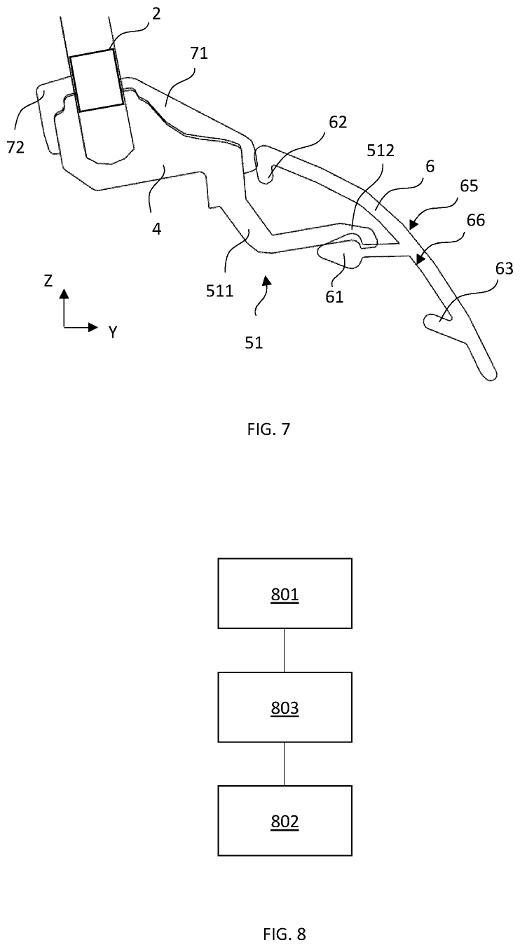

FIG. 7 illustrates a top element according to the invention. In some embodiments, the top element 51 can have an arm 511 designed to be flexible in a direction substantially perpendicular to the axis of penetration of a trim element to be plugged into the clip-like assembly even if the bottom element is made of a rigid material such as Polypropylene, meaning that the shape, the length, the thickness and/or the width can vary depending on the application and on the trim element to plug. The bottom element can also comprises an end part 512. The end part can comprises a hook-like element to maintain a trim element once the trim element is plugged into the clip-like assembly.

### <Tongue-Like Element>

In some embodiments, as illustrated in FIG. 3, FIG. 4 and FIG. 6, to guide in order that the trim element is moved in correct direction, along the Y-axis in this representation, the at least one clip-like assembly comprises a tongue-like element 53 between the top element and the bottom element. Thus, the tongue-like element 53 has a shaped element 531 designed to guide a trim element to be correctly plugged and maintained between the top element and the bottom element.

The tongue-like element 53 can also comprises a stopper 532 to avoid to push to mush inward a trim element into the clip-like assembly.

As illustrated in FIG. 3, the top element 51 has a length L51, measured along the Y-axis, the bottom element 52 has a length L52, measured along the Y-axis, and the tongue-like element 53 has a length L53, measured along the Y-axis.

In some embodiments, depending on the desired applications and trim element to plug, the length L51 is comprises between 8 mm and 12 mm ([8 mm≤L51≤12 mm]), preferably the length L51 is comprises between 9 mm and 11 mm ([9 mm≤L51≤11 mm]), more preferably the length L51 is about 9.5 mm (L51=9.5 mm).

In some embodiments, depending on the desired applications and trim element to plug, the length L52 is comprises between 8 mm and 12 mm ([8 mm≤L52≤12 mm]), preferably the length L52 is comprises between 9 mm and 11 mm ([9 mm≤L52≤11 mm]), more preferably the length L52 is about 9.5 mm (L52=9.5 mm).

In some preferred embodiments, the length L51 of the top element and the length L52 are substantially the same (L51=L52).

In some preferred embodiments, the length L53, measured along the Y-axis, of the tongue-like element 53, is longer than the lengths L51 and L52.

In some embodiments, depending on the desired applications and trim element to plug, the length L53 is comprises between 10 mm and 15 mm ([10 mm≤L53≤15 mm]), preferably the length L53 is comprises between 12 mm and 14 mm ([12 mm≤L53≤14 mm]), more preferably the length L53 is about 12.4 mm (L52=12.4 mm).

As illustrated in FIG. 4, the top element 51 has a width W51, measured along the X-axis, the bottom element 52 has a width W52, measured along the X-axis, and the tongue-like element 53 has a width W53, measured along the X-axis.

In some embodiments, depending on the desired applications and trim element to plug, the width W51 is comprises between 12 mm and 18 mm ([12 mm≤W51≤18 mm]), preferably the width W51 is comprises between 14 mm and 17 mm ([14 mm≤W51≤17 mm]), more preferably the width W51 is about 15 mm (W51=15 mm).

In some embodiments, depending on the desired applications and trim element to plug, the width W52 is comprises between 12 mm and 18 mm ([12 mm≤W52≤18 mm]), preferably the width W52 is comprises between 14 mm and 17 mm ([14 mm≤W52≤17 mm]), more preferably the width W52 is about 15 mm (W52=15 mm).

In some preferred embodiments, the width W51 of the top element and the width W52 are substantially the same (W51=W52).

In some preferred embodiments, the width W53, measured along the X-axis, of the tongue-like element 53, is shorter than the widths W51 and W52.

In some embodiments, depending on the desired applications and trim element to plug, the width W53 is comprises between 3 mm and 7 mm ([3 mm≤W53≤7 mm]), preferably the width W53 is comprises between 4 mm and 6 mm ([4 mm W53≤6 mm]), more preferably the width W53 is about 5 mm (W53=5 mm).

FIG. 5 to FIG. 7 shows that the at least one clip-like assembly and the primary part are formed as a single component. That means that the at least one clip-like assembly is part of the primary part and the at least one clip-like element is created during the injection of the primary part and with the primary part. Thus, the at least one clip-like element is made of the same component than the primary part.

In such representations, the top element 51 is alone on one side of the tongue-like element 53 such as the bottom element 52 on the other side, meaning that there is no other element designed to plug and to maintain the trim element in front of, in the Z-axis, the top element and in front of, in the Z-axis, the bottom element. The plug of the trim element is done, for one clip-like element, only by the top element and the bottom element.

In some preferred embodiments, the primary part comprises at least two clip-like elements arranged to stabilise a trim element to plug into.

In some embodiments, depending on the desired application, and especially the length, measured along the X-axis, of the trim element to plug into, the primary part 4 can comprises as many clip-like elements 5 as necessary along the edge of the window unit to hidden by a trim element.

Preferably, in such embodiments, the primary part 4 comprises extensions 41 between two clip-like elements 5 to ensure the mechanical strength at least at the portion to be masked by the trim element.

In some embodiments, depending on the desired applications and trim element to plug, the width W5 of the clip-like element 5 is at least the sum of the widths W51, W52 and W53 with at least a space between the top element, the tongue-like element and the bottom element. For widths W51 and W52 of about 15 mm, W53 of about 5 mm, the width W5 is about 40 mm.

To ensure the independent flexibility of the top element and the bottom element, a space can be create between the top element and the bottom element. In some embodiments, the tongue-like element 53 is separated, along the edge of the primary part, to the top element 51 by a space 54 and the tongue-like element 53 is separated, along the edge of the primary part 4, to the bottom element 52 by a space 55. Spaces are created along the edge meaning along the X-axis in such representation.

The space permits to create a specific 3D shape for the top element and for the bottom element to ensure the individual flexibility of the top element and of the bottom element.

In such representations, the top element has a generic S-shape in the plane Y-Z while the bottom element has a generic C-shape in the plane Y-Z, theses shapes allow to have a good balance between the elasticity and the rigidity of clip-like element to fix efficiently the decorative strip through the rigid part. The top and the bottom elements are elongating from the primary part starting from the top part, meaning the portion of the primary part that has the higher value along the Y-axis, of the primary part.

It is understood that any other shapes, starting parts of the top element and/or the bottom element that permits the flexibility of the top and the bottom part can be used.

The trim element illustrated in FIG. 2 is about 600 mm. The primary part can comprises five clip-like elements to ensure the trim element is correctly fixed once plugged. The distance between two clip-like elements can be about 118 mm.

The present invention relates also to a method to produce a window unit according to the first aspect, wherein the method comprises a step of injecting the primary part and the at least one clip-like assembly in a single step onto the glazing panel.

Preferably, the step of injecting is preceded by a step of inserting the glazing panel into a mold.

The present invention also relates to a mold to produce a window unit according to the first aspect. The mold is designed to receive at least a part of the glazing unit on which the primary part will be inserted. It is understood that only the part of the glazing panel to be injected or the whole glazing panel can be inserted into the mold.

According to the invention, the mold comprises a cavity to create by an injection the primary part and the at least one clip-like assembly.

The mold comprises a top part and a bottom part. The parts can close up creating the cavity. The cavity is sealed once the parts are closed. The mold comprises at least one injection nozzle to inject into the cavity the primary part.

The present invention also relates to a method to assemble a vehicle glazing unit according to the second aspect of the invention, as illustrated in FIG. 8. Said method comprises following steps:
Step A. Providing (801) a glazing unit according to any claims 1 to 8
Step B. Providing (802) a trim element comprising a lug designed to be clipped and maintained in a clip-like assembly;
Step C. Assembling (803) the trim element by clipping the lug between the top element and the bottom element of the at least one clip-like element.

The step C of assembling the trim element by clipping the lug between the top element and the bottom element of the at least one clip-like element can be made by pushing the trim element substantially along the Y-axis. During the insertion of the lug into the clip-like element, because the top element and the bottom element are designed to be flexible in a direction (Z-axis) substantially perpendicular to the axis (Y-axis) of penetration of a trim element to be plugged into the clip-like assembly, the top element is deformed along the Z-axis meaning that the end part 512 of the top element is moving in +Z, the bottom element deformed along the Z-axis meaning that the end part 522 of the top element is moving in-Z. The top element and the bottom element are designed to be flexible it means that they are able to be geometrically deformed under the penetration constraint of a lug of a trim element and they can retrieve their original shape once the constraint is released or the lug is correctly inserted allowing to maintain the trim element plugged into the window unit.

1. A window unit comprising:
a glazing panel; and
a frame which has a frame profile and encompasses an edge of the glazing panel on at least two peripheral sides, and grips the glazing panel or encompasses the glazing panel on at least two peripheral sides in a form of a ring, the frame comprising a primary part which is in the form of a hard component,
wherein the primary part of the frame comprises an at least one clip-like assembly, the clip-like assembly comprises a top element, and a bottom element, the at least one clip-like assembly being designed to clip and maintain a lug of a trim element between the top element and the bottom element,
wherein the top element is shifted from the bottom element along the edge,
wherein the at least one clip-like assembly and the primary part are formed as a single component, and
wherein the top element and the bottom element are designed to be flexible in a direction substantially perpendicular to an axis of penetration of the trim element to be plugged into the at least one clip-like assembly.

2. The window unit according to claim 1, wherein the at least one clip-like assembly comprises a tongue-like element between the top element and the bottom element.

3. The window unit according to claim 2, wherein the tongue-like element is separated, along the edge of the primary part, to the top element by a first space and the tongue-like element is separated, along the edge of the primary part, to the bottom element by a second space.

4. The window unit according to claim 1, wherein the hard component is a polypropylene based material.

5. The window unit according to claim 1, wherein the frame comprises a secondary part which is in the form of a soft component placed at least partially over the primary part.

6. The window unit according to claim 5, wherein the soft component is a thermoplastic elastomer based material.

7. The window unit according to claim 1, wherein the primary part is in direct contact with the glazing panel.

8. The window unit according to claim 1, wherein the glazing panel comprises a glass panel.

9. The window unit according to claim 1, wherein the glazing panel comprises a laminated glass panel.

10. A vehicle window unit comprising:
a window unit according to claim 1,
a trim element comprising a lug designed to be clipped and maintained in the at least one clip-like assembly,
wherein the lug is inserted into the at least one clip-like assembly between the top element and the bottom element.

11. A method to produce the window unit according to claim 1, comprising injecting the primary part and the at least one clip-like assembly in a single step onto the glazing panel.

12. The method to assemble a vehicle glazing unit according to claim 10, comprising:
providing the glazing unit;
providing the trim element; and
assembling the trim element by clipping the lug between the top element and the bottom element of the at least one clip-like element.

13. A mold to produce a window unit according to claim 1, the mold being designed to receive at least a part of the glazing unit on which the primary part will be inserted, wherein the mold comprises a cavity to create by injection the primary part and the at least one clip-like assembly.

14. (canceled)
